(19) United States
(12) Patent Application Publication
(10) Pub. No.: US 2004/0219951 A1
(43) Pub. Date: Nov. 4, 2004

(54) Program controlled apparatus, system and method for remote data messaging and display over an interactive wireless communications network

(76) Inventor: Helen A. Holder, Sunnyvale, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/425,427

(22) Filed: Apr. 29, 2003

(51) Int. Cl. H04B 1/38

(52) U.S. Cl. 455/566; 455/556.2; 455/466

(57) ABSTRACT

This disclosure relates to a program controlled apparatus, system and method for remote data messaging and display over an interactive wireless communications network. The system comprises a wireless communications network, a wireless data receiver, a communications device having a portal for transmitting data to the receiver, a non-mobile display screen associated with the receiver for showing text and graphic data transmitted over the network, a microprocessor associated with the receiver for decoding, processing and storing data received, a power source for operating the system, and programming for desired management and display of messages based upon the data received including programming for allowing a data inquiring party to pull selected data.

### FIELD OF THE INVENTION

The present invention relates generally to network data communications and, more particularly, to a program controlled apparatus, system and method for remote data messaging and display over a wireless interactive communications network or the like.

### BACKGROUND OF THE INVENTION

Conventional devices for leaving messages at the home or office have ranged from the highly sophisticated, such as the personal digital assistant, to the old fashioned, i.e., pencil and paper. A universal objective is to enable a message leaving party to simply and efficiently communicate selected information to an inquiring party, in the message leaving party's absence.

Over the last decade or so, numerous advances in interpersonal communications technology have been made. These improvements have included telephone voicemail systems, cellular telephones, pagers, personal digital assistants and electronic mail. While each of these arrangements has proven useful, the hand-written “note” has remained the most common way of leaving messages at the home or office.

Typically, a message is written on a piece of paper and affixed to a stationery surface using a pushpin or piece of tape. Another popular approach uses a message pad or board with an accompanying writing instrument (such as a pen or pencil) and eraser. Commonly, a pad of paper is mounted to a door or bulletin board with a pencil dangling from a string or stuck to the board with VELCRO. Alternatively, an article such as a message board is utilized, having a relatively flat, erasable slate or laminated writing surface. A marker pen or chalk and a dry eraser are also provided. The pad or board is located and oriented where an inquiring party is most likely to notice it; typically, on the outside of the worker's office door, workstation cubical, or adjacent to a telephone.

In use, the message leaving party hand writes a text or graphic message intended to communicate selected information to an inquiring party. Such information indicates, for instance, a date and time when the message leaving party is expected to return. It may also indicate the whereabouts of the message leaving party, a telephone number where the party can be reached and/or a particular meeting place or time.

By this approach, conventional wisdom is that virtually anyone within eyeshot of the messaging article or medium receives the most current information intended from the message leaving party. This assumes, however, that the message leaving party remembered to leave a message before leaving the premises. It also assumes that any information that may have been left is static in nature, namely, that it may not have to be changed at a later date or time. This is especially problematic in the dynamic information environment, such as when arrival times, telephone or other contact information change during the course of the day.

One solution has been for the message leaving party to contact someone such as a coworker who is in proximity to the message pad or board, and instruct him or her to change the message. While plausible, as a practical matter the message leaving party may not be able to reach or otherwise rely upon anyone to change the message posted in a timely fashion. Accordingly, once the message leaving party has left the premises, he or she may be helpless to update message information or to provide additional information in a timely fashion. As a result, any inquiring party is likely to be confused or mislead by the information provided.

In technical terms, the foregoing involve an information “pull” type system, that is, in order to retrieve or otherwise access information from a message leaving party, an inquiring party must physically go to the message medium (e.g., message pad or board) and read it. The context of providing such information is to not only post data, but also share it with a group of individuals, as in a home, educational, office or industrial environment.

Although traditional “pull” systems have been found helpful in the static information realm, most message information is subject to change and, therefore, may require periodic updating. Accordingly, when a message leaving party is at a remote location and can not readily return to the place of the message pad or board to provide updates, as that party's information changes, he or she must somehow make information updates available for the inquiring party. Furthermore, these systems have been found slow and inconvenient.

Another option is for the message leaving party to provide updated information using a land-based telephone, cellular telephone, Internet portal device such as a PALM PILOT, remote wireless e-mail or other text messaging device. The message leaving party simply leaves a message with the inquiring party's telephone voice mail system, if available, or by electronic mail. Unfortunately, the message leaving party may not and often does not know who will be making inquiries, when such inquiries will be made, or what sort of information will be desired by an inquiring party. The effectiveness of this arrangement also depends upon the message leaving party, namely, whether he or she has, or has access to, such a device, remembered to bring it with them, has it turned on and has it charged. It further assumes that the user is interested in receiving inquiries—as users do not necessarily answer their pagers or cellular telephones.

Accordingly, while helpful, these approaches have not only been found costly and inconvenient, but also unreliable—due to possible software and/or equipment failure, potential unreliability of the message leaving party, and possible inaccessibility of the requisite equipment. Moreover, they have been found generally ineffective for use, as is commonly the case, when neither the party that will be making the inquiry, nor the date and time such inquiry will be made, are known.

Unless the message leaving party is readily reachable at the remote location through one of the aforementioned devices, there is no practical way for a message leaving party to keep his or her message information current for an unknown inquiring party, or for such party to contact the message leaving party upon learning that such information is not up-to-date. In addition, such information may not be received when needed or when desired by the unknown inquiring party. Hence, a dilemma of sorts is presented.

To meet this challenge, message leaving parties have utilized information “push” type systems. More particularly, the message leaving party would transmit or otherwise provide information to any inquiring party who might desire it by blanketing or broadcasting such information to each and every user in a selected field. An objective is to insure information access by providing updates to anyone and everyone who could possibly want it. Examples include leaving a message in a general company voice mail box or sending electronic mail to all user's in a selected field. Simply stated, everyone receives the information contained in the message, whether it is intended for or desired by every recipient or not.

Although beneficial, there remains no practical way for the message leaving party to selectively “push” information, on command, to an unknown inquiring party who desires it—at least not without distracting everyone else in the receiving field with information that is irrelevant, or through manual intervention of the message leaving party. Moreover, such overreaching in providing information has made these systems unsuitable for distribution of confidential and other proprietary information

Finally, public messaging systems, whether wireless or land based, have also been utilized by message leaving parties to communicate information updates. While useful, their output has usually been limited to relatively large billboard-type displays. Additionally, they require that content be distributed from a central location. Accordingly, these systems have been found relatively expensive to implement and operate. They also require manual intervention and target any user who is within visual range, making these systems unsuitable for distribution of confidential and other proprietary information. Consequently, conventional public messaging systems have not only been found slow and inconvenient, but also of limited use in information content and practicality.

An apparatus, a system and a method are, therefore, desired for effectively (i) providing real-time information that can be shared with groups of people simultaneously but independently, (ii) that are adaptable to larger, existing multi-channel public messaging systems, (ii) that allow a single user to “pull” information as needed, (iii) that provide remote information updates through a wide range of methods, and (iv) retain a traditional marking surface, without the need for a personal messaging device nor manual, on-site intervention.

### SUMMARY OF THE INVENTION

A specific, illustrative system is provided for remote data messaging and display over an interactive wireless communications network. The system comprises a wireless communications network, a wireless data receiver, a communications device having a portal for transmitting data to the receiver, a non-mobile display screen associated with the receiver for showing text and graphic data transmitted over the network, a microprocessor associated with the receiver for decoding, processing and storing data received, a power source for operating the system, the system having programming for management and display of messages based upon the data received, and for allowing a data inquiring party to pull selected data.

Another specific, illustrative system is provided for remote data messaging and display over an interactive wireless communications network. The system comprises a wireless communications network, a multi-channel wireless data receiver, a communications device having a portal for transmitting data to the receiver, a non-mobile, large screen display associated with the receiver for showing text and graphic data transmitted through the network, a power source for operating the system, and a microprocessor associated with the receiver for decoding, processing and storing data received, the system having programming for management and display of messages based upon the data received, and for public messaging.

A further specific, illustrative system is provided for remote data messaging and display over an interactive wireless communications network. The system comprises a wireless communications network, a wireless data receiver, a communications device having a portal for transmitting data to the receiver, a non-mobile display screen associated with the receiver for showing text and graphic data transmitted over the network and suitable for temporary marking, a power source for operating the system, and a microprocessor associated with the display screen for decoding, processing and storing data received, the system having programming for management and display of messages based upon the data received, and for allowing a data inquiring party to pull selected data.

Yet a further specific, illustrative system is provided for remote data messaging and display over an interactive wireless communications network. The system includes a wireless communications network; a wireless data receiver; a wireless communications device having an electronic pencil, a data input and display screen for preparing hand written data messages thereon using the electronic pencil, and having a portal for transmitting the data messages to the wireless data receiver; a page size, LCD display surface suitable for electronic marking and for showing hand written data transmitted over the network; a message input device including an electronic pencil for on-site data input; a power source for operating the apparatus; and a microprocessor associated with the display surface for decoding, processing and storing data input on-site or received remotely, the system having programming for management and display of messages based on the data input on-site or received remotely.

A specific, illustrative program controlled apparatus is also provided for remote data messaging and display over an interactive wireless communications network. The apparatus includes a wireless data receiver, a non-mobile display screen for showing text and graphic data transmitted over the network, a power source for operating the apparatus, a message input device for on-site data input, and a microprocessor associated with the display screen for decoding, processing and storing data input on-site or received remotely, the apparatus having programming for management and display of messages based upon data input on-site or received remotely.

Another specific, illustrative program controlled apparatus is provided for remote data messaging and display over an interactive wireless communications network. The apparatus includes a wireless data receiver, a non-mobile display screen suitable for temporary marking for showing text and graphic data transmitted over the network, a power source for operating the apparatus, a message input device for on-site data input, a microprocessor associated with the display screen for decoding, processing and storing data input on-site or received remotely, the apparatus having programming for management and display of messages based upon data input on-site or received remotely.

Still another specific, illustrative program controlled apparatus is provided for remote data messaging and display over an interactive wireless communications network. The apparatus includes a multi-channel wireless data receiver, a non-mobile, large screen display associated with the receiver for showing text and graphic data transmitted over the network, a message input device for on-site data input, a power source for operating the apparatus, and a microprocessor associated with the receiver for decoding, processing and storing data input on-site or received remotely, the apparatus having programming for management and display of messages based upon data input on-site or received remotely, and the multi-channel receiver allowing for different user's updating their information on a single screen.

Yet another specific, illustrative program controlled apparatus is provided for remote data messaging and display over an interactive wireless communications network. The apparatus includes a wireless data receiver, a page size, LCD display surface suitable for temporary marking and for showing text and graphic data transmitted over the network, a message input device including a keyboard for on-site data input, a power source for operating the apparatus, and a microprocessor associated with the display surface for decoding, processing and storing data input on-site or received remotely, the apparatus having programming for management and display of messages based on the data input on-site or received remotely.

Still a further specific, illustrative program controlled apparatus is provided for remote data messaging and display over an interactive wireless communications network. The apparatus includes a wireless data receiver, a page size, LCD display surface suitable for electronic marking and for showing text and graphic data transmitted over the network, a message input device including an electronic pencil for on-site data input, a power source for operating the apparatus, and a microprocessor associated with the display surface for decoding, processing and storing data input on-site or received remotely, the apparatus having programming for management and display of messages based on the data input on-site or received remotely.

In addition, a specific, illustrative method is provided for remote data messaging and display over an interactive wireless communications network. Initially, a message leaving party compiles a message intended for one or more inquiring party. Next, using a communications device having a portal for transmitting message data, the message leaving party transmits data corresponding to the message over a wireless communications network to a wireless data receiver. Upon receiving the message data, the receiver sends the data to a non-mobile display screen for showing the data in text and graphic data formats, the receiver having a microprocessor for decoding, processing and storing the message data received and a power source. The receiver also has programming for management and display of messages based upon the data received, and for allowing the inquiring party to pull selected data therefrom.

Another specific, illustrative method is provided for remote data messaging and display over an interactive wireless communications network. Initially, a message leaving party compiles a message intended for one or more inquiring party. Next, using a communications device having a portal for transmitting message data, the message leaving party transmits data corresponding to the message over a wireless communications network to a multi-channel wireless data receiver. Upon receiving the message data, the receiver sends the data to a non-mobile, large screen display for showing the data in text and graphic data formats, the receiver having a micro-processor for decoding, processing and storing the message data received and a power source. The receiver also has programming for management and display of messages based upon the data received, and for public messaging.

A further specific, illustrative method is provided for remote data messaging and display over an interactive wireless communications network. Initially, a message leaving party compiles and writes a message intended for one or more inquiring party on a non-mobile display screen suitable both for temporary marking and for showing message data electronically in text and graphic data formats. Next, using a communications device having a portal for transmitting message data, the message leaving party transmits data corresponding to the message over a wireless communications network to a wireless data receiver. Upon receiving the message data, the receiver sends the data to a non-mobile display screen for showing the data in text and graphic data formats, the receiver having a microprocessor for decoding, processing and storing the message data received and a power source for operating the screen, receiver and microprocessor. The system also has programming for management and display of messages based upon the data received, and for allowing the inquiring party to pull selected data therefrom.

Accordingly, it is an object of the present invention to provide an improved program controlled apparatus, system and method for remote data messaging and display over an interactive wireless communications network or the like.

Another object of the present invention is to provide a program controlled apparatus, system and method of sharing real-time data with selected data recipients.

A further object of the present invention is to make real-time data available simultaneously to one or more inquiring parties of a group.

Still another object of the present invention is to provide a program controlled apparatus, system and method of making data available through an information “pull” system that allows a message inquiring party to access and retrieve selected data sets when and as desired.

Yet another object of the present invention is to provide a program controlled apparatus, system and method for transmitting data to a selected location for access by one or more inquiring parties without the need for a personal data transmission device.

Still a further object of the present invention is to provide a program controlled apparatus, system and method that allows a user to transmit data updates remotely, without manual intervention by an inquiring party who wishes to become a recipient of the same.

Yet a further object of the present invention is to provide a program controlled apparatus, system and method for remote data messaging and display over an interactive wireless communications network or the like that retains a traditional, temporary marking surface.

Another object of the present invention is to provide a program controlled apparatus, system and method for remote data messaging and display over an interactive wireless communications network that is readily adaptable for use with a relatively large, multi-channel public messaging system.

Still a further object of the present invention is to provide a public messaging system that is fast, convenient and practical to use, as well as adaptable for use with any data content.

Yet another object of the present invention is to provide a program controlled apparatus and system for remote data messaging and display over an interactive wireless communications network that is durable, reliable and may be operated with minimal vigilance of the user.

Another object of the present invention is to provide a program controlled apparatus and system for remote data messaging and display over an interactive wireless communications network, that may be constructed of low cost materials.

A further object of the present information is to provide a program controlled apparatus and a system that is readily adaptable to existing interactive wireless communications networks.

Still another object of the present invention is to provide a program controlled apparatus and system for remote data messaging and display over an interactive wireless communications network that is both efficient and economical.

Yet a further object of the present invention is to provide a program controlled apparatus, system and method for remote data messaging and display over an interactive wireless communications network that provides appropriate security for transmission of interpersonal and other confidential information.

Still a further object of the present invention is to permit a user to not only remotely provide data messaging and display over an interactive communications network, but also to tag the data displayed as to arrival time, priority and/or importance.

Another object of the present invention is to provide a program controlled apparatus and system for remote data messaging and display over an interactive wireless communications network, which operates in compliance with existing message protocols such as SMS.

The present invention will now be further described by reference to the following drawings which are not intended to limit the accompanying claims.

### BRIEF DESCRIPTION OF THE DRAWINGS

FIG. 1 is a schematic illustration showing a specific, illustrative program controlled system for remote data messaging and display over an interactive wireless communications network, according to the present invention;

FIG. 2 is a flow diagram illustrating hardware components of a specific, illustrative program controlled apparatus of the system set forth in FIG. 1;

FIG. 3 is a flow diagram illustrating hardware components of a specific, illustrative program controlled apparatus of the system set forth in FIG. 1, according to another aspect of the present invention;

FIG. 4 is a flow diagram illustrating hardware components of the program controlled apparatus of the system set forth in FIG. 1;

FIG. 5 is a plan view of a specific, illustrative program controlled data messaging board, in accordance with the present invention;

FIG. 6 is a plan view of another specific, illustrative program controlled data messaging board;

FIG. 7 is a plan view of a further specific, illustrative program controlled message board, according to the present invention;

FIG. 8 is plan view of a yet another specific, illustrative program controlled message board of the present invention;

FIG. 9 is an electronic schematic diagram showing a receiver circuit, according to one embodiment of the present invention;

FIG. 10 is an electronic schematic diagram showing a transmitter circuit, in accordance with one arrangement according to the present invention;

FIG. 11 is a flow diagram showing a specific, illustrative program controlled system for remote data messaging and display over an interactive wireless communications network, in accordance with the present invention;

FIG. 12 is a flow diagram showing another specific, illustrative program controlled system for remote data messaging and display over an interactive wireless communications network;

FIG. 13 is a flow diagram showing a further specific, illustrative program controlled system for remote data messaging and display over an interactive wireless communications network, according to another aspect of the present invention;

FIG. 14 is a flow diagram showing yet another specific, illustrative program controlled system for remote data messaging and display over an interactive wireless communications network;

FIG. 15 is a plan view of a specific, illustrative program controlled messaging board having a multi-channel receiver;

FIG. 16 is a schematic illustration of a specific, illustrative wide area wireless network (WAWN) of the present invention;

FIG. 17 is a schematic illustration of a local area wireless network (LAWN) in accordance with one embodiment of the present invention; and

FIG. 18 is a schematic illustration of a specific, illustrative system for real-time visual messaging and notification, according to the present invention.

The same numerals are used throughout the figure drawings to designate similar elements. Still other objects and advantages of the present invention will become apparent from the following description of the preferred embodiments.

### DETAILED DESCRIPTION OF THE PREFERRED EMBODIMENTS

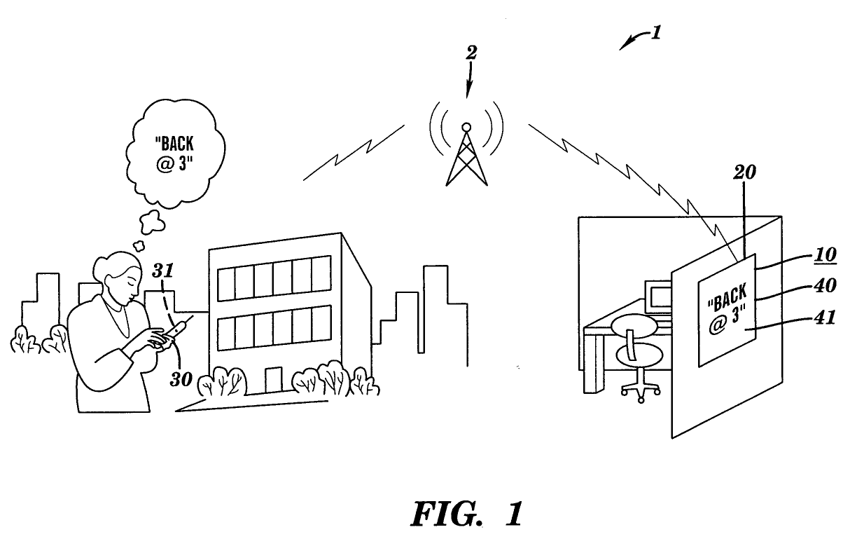

Referring now to the drawings and more particularly to FIGS. 1-18, there is shown generally a specific, illustrative system 1 for remote data messaging and display over an interactive wireless communications network 2, in accordance with the present invention. Generally speaking, as illustrated in FIG. 1, the system comprises a program controlled apparatus for allowing a message leaving party to post a text-based message and/or update the message for local or public access. The system also includes a wireless data receiver 20, a communications device 30 having a portal 31 for transmitting data to the receiver, and a local display 40, preferably a non-mobile display screen 41 or the like, associated with the receiver for showing text and graphic data transmitted over the network. At the kernel of the system is program controlled apparatus 10, preferably having one-way receiving capability, for allowing the message leaving party to post or update text-based and/or graphics-based messages.

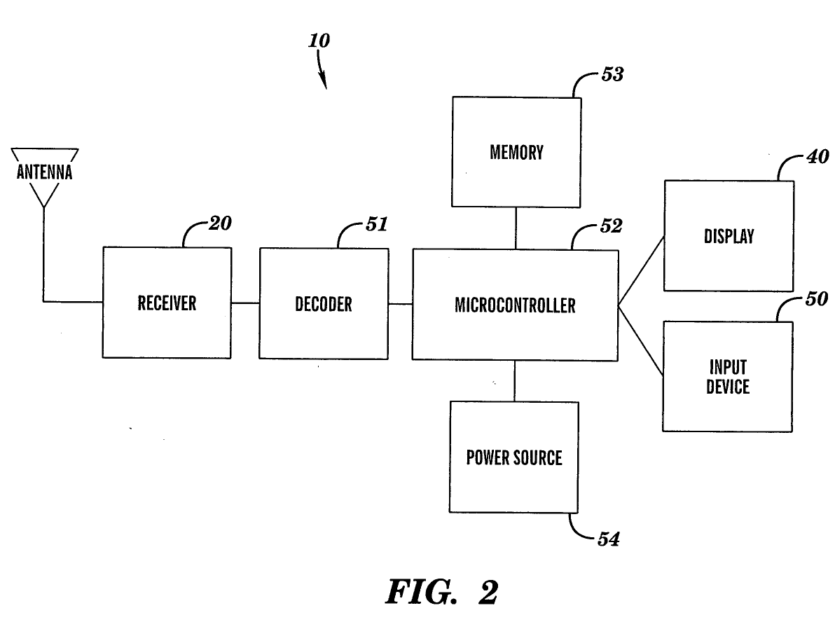

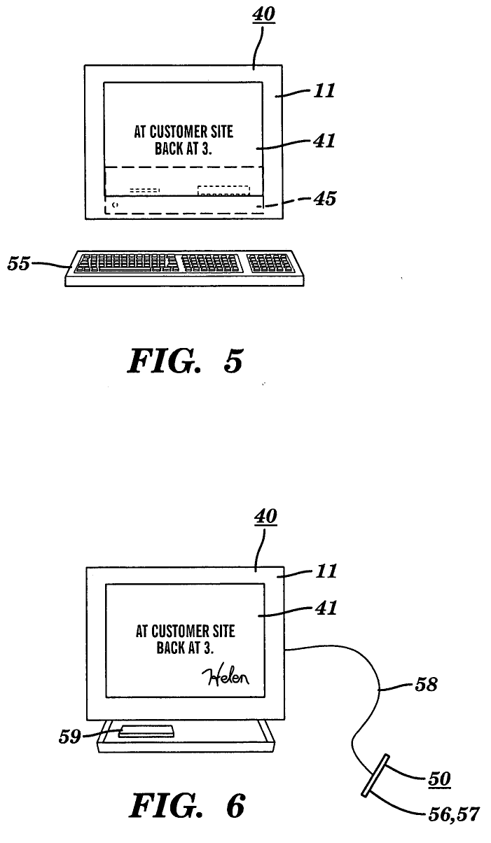

As best seen in FIGS. 5-8, a housing 11 is provided for mounting the display screen and enclosing the wireless data receiver. In one embodiment, the housing is constructed preferably of one or more polymeric materials such as polyethylene, e.g., HID 112 manufactured by Chevron Corporation, for optimum durability and non-interference with data transmission. As shown in FIG. 2, also mounted to the housing is an input device 50 for generating messaging data, a decoder device 51, e.g., of a conventional type such as Motorola Flex or the like, for decoding the data received, a microcontroller 52 desirably associated with the receiver for processing the data received, a memory device 53 for storing the processed data, and a power source 54, e.g., a conventional lithium-based battery, for operating the system. The microcontroller is provided with programming for desired management and display of messages based upon the data received, as well as programming for allowing a data inquiring party to pull or otherwise access selected data therefrom. Also, compliance of the system with existing message protocols such as SMS is understood, within the spirit and scope of the present invention.

Advantageously, the apparatus is integrated within wireless communications network 2, preferably of a conventional type, suitable for text and/or graphic based messaging, such network being inclusive of, but not limited to, the Internet. In this manner, data may be received readily using existing wireless digital data transmission networks, cell towers, and digital data transmission devices such as pagers, cellular telephones, PDA's or the like.

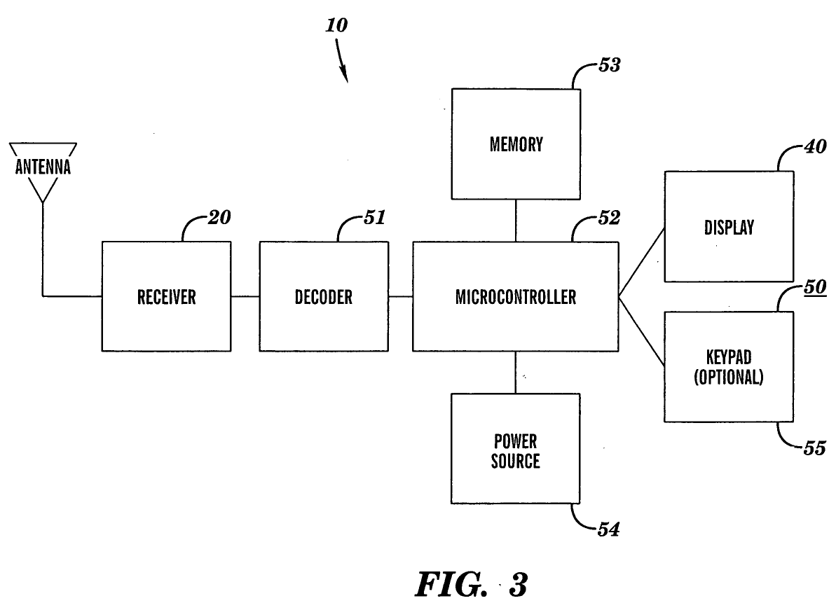

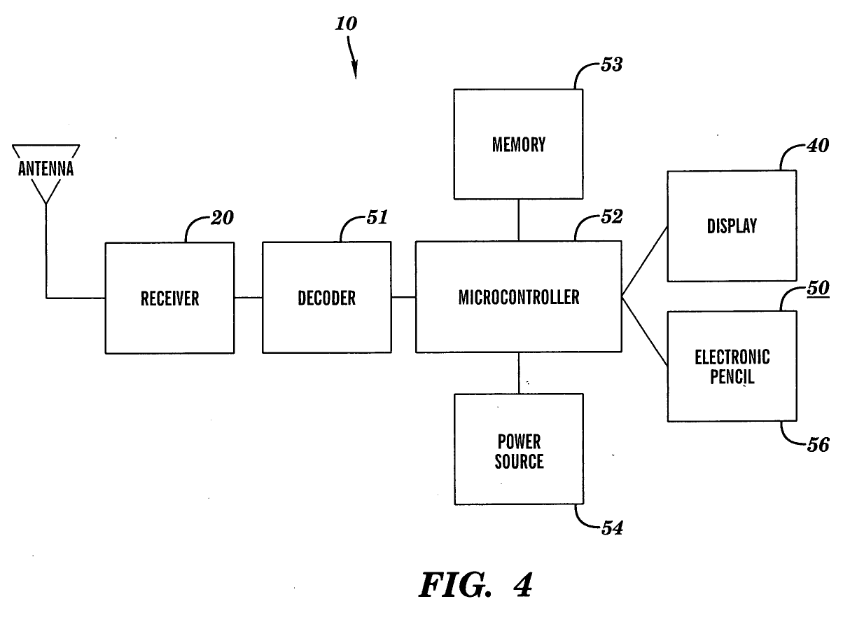

In one embodiment, set forth in FIGS. 3 and 5, input device 50 comprises a keyboard or keypad 55. This enables the message leaving party to generate and post a text message on the display screen 41 on-site for subsequent updating. Alternatively or concurrently, an electronic pencil or stylus 56 is provided, e.g., a pointing device with advanced features such as a digital pen with Microsoft Tablet PC interface, is provided. Desirably, display screen 41 is both touch and write sensitive, e.g., a Sharp passive matrix LCD p/n LM038QBITS10 or the like, so that the message leaving party may scribe the message on the screen by hand. The message is then stored as positional data in the memory device for continuous display and/or subsequent remote updating. An arrangement of this general description is shown in FIGS. 4 and 6.

Further alternatively to or concurrently with the above, a conventional mechanical writing instrument such as an erasable ink marker 57 is provided, e.g., suspended from the housing by a cord or string 58, and a correspondingly appropriate transparent polymeric writing surface material, e.g., a GBC write/erase laminating film, also suitable for electronic display applications. A marker eraser 59 is also provided, e.g., in a tray below the screen, for permitting the message leaving party to erase the message upon his or her return.

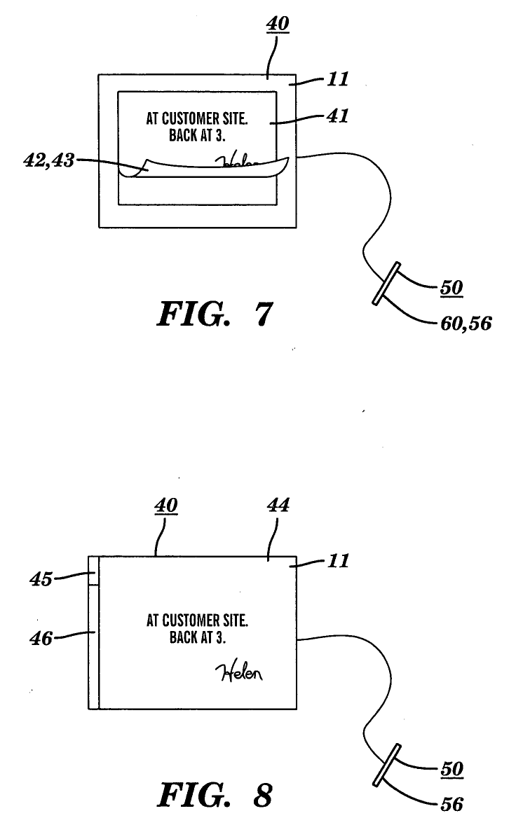

According to another embodiment, illustrated in FIG. 7, the screen and writing instrument comprise a peel-and-sketch-like arrangement. The message leaving party leaves a message by writing a desired message on the screen using non-electronic probe or stylus 60, the screen being covered by a pressure activated, electronic film 42. Alternatively, electronic pencil 56 may be used in conjunction with an electronic activated film 43. Upon transmission of an updated message from a remote location, the apparatus is activated so as to apply a selected voltage to the screen, thereby deactivating and erasing the previous message. The updated message, in turn, appears on the screen electronically. In this connection, it is considered desirable that the display screen be suitable for non-permanent or temporary marking, whether done electronically, mechanically or chemically, giving consideration to the purpose for which the present invention is intended.

Still another specific, illustrative program controlled apparatus is provided with a page size screen display such as an LCD display surface 44, e.g., 8½ inches×11 inches, preferably suitable both for mechanical and/or electronic marking, and for showing hand written data transmitted over the network. An apparatus of this general description is shown in FIG. 8. Message input device 50 is also provided including, alternatively or concurrently, electronic pencil 56 for on-site data input by the message leaving party. A microcontroller 45, associated with the display surface, is preferably adapted for processing data input on-site or received remotely and a memory device 46 stores the data for display. The microcontroller also has programming, e.g., conventional software, for desired management and display of messages based on data input on-site or received remotely.

In yet another embodiment, outdoor type displays are used for display of electronic messages. Exemplary outdoor display screens include, but are not limited to, the ALPHA Solar Outdoor LED Sign manufactured by AMS, Inc. and/or the ALPHAEclipse 3500, 1-4 Outdoor LED Sign, also produced by AMS, Inc. These signs are considered particularly well-suited to a wide range of outdoor applications, such as public display of information at airports and train stations; advertising information at automobile dealerships, shopping centers and other retail establishments; customer information at bank and fast food drive-thrus; and employee communications at plant and company entrances; student and teacher information in schools; parishioner information in churches or the like.

Still another suitable display may take the form of a conventional scoreboard such as those used during athletic and other spectator events, e.g., a TRANS-LUX display with a PROLINE, Windows® 98 or NT® based computer interface, wireless controller and MP70 wireless system, and LED and bar digits, a product of Trans-Lux Sports, Inc., which has been found suitable for live video footage, recorded video, cable TV, newswire feeds and animations.

Although the present invention is shown and described as utilizing conventional technology for presenting information using particular types and/or sizes of on-site display screens, it will be understood by those skilled in the art that other displays may be used, depending upon and giving consideration to the purpose for which the present invention is intended. For instance, LCD, LED, CRT, plasma, high definition and/or like display technologies may also be implemented, within the spirit and scope of the present invention.

Optionally, the various displays according to the present invention may be provided with multicolor capability for enhanced readability and improved communication to the inquiring party. In one embodiment, each class of information updates is displayed in a selected color according to a pre-programmed color pallet, each color correlating with an information priority protocol. By one protocol, CURRENT information is displayed in GREEN, whereas URGENT information, e.g., new arrival or contact information, is displayed in RED. When information displayed as CURRENT is about to be updated remotely by a message leaving party, namely, upon receiving a signal from the remote site that such alteration is pending, the color of the current information displayed is changed from GREEN to YELLOW. Moreover, information that has been updated remains on the screen in PURPLE so that an inquiring party can see that there have been delays and deduce that further delays are possible. Information that is CURRENT but considered by the message leaving party to be of particular importance is displayed in RED.

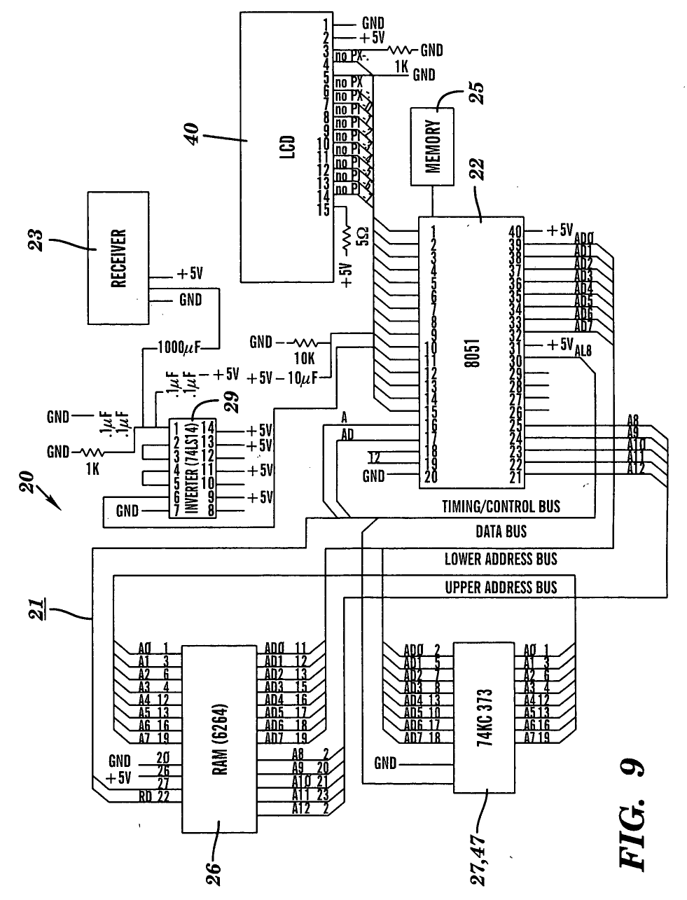

Referring now to another feature of the present invention, wireless data receiver 20 comprises a receiver circuit 21 and associated display 40 for presenting current information to the message inquiring party (a.k.a. message receiving party), and also for receiving information updates transmitted to that party by communications device 30. The receiver circuit includes, e.g., an 8051 microprocessor 22, and a receiver unit 23. A circuit of this general description is shown in FIG. 9. Notably, operations handled by display microcontroller 45 and receiver micro-processor 22 may be shared by a single microcontroller unit, as will be appreciated by those skilled in the art.

It is preferred that information be displayed by rotating the text and graphic information across screen 41. In one embodiment, the current information is shown, e.g., relatively continuously on the left side of the screen and the updates are rotated across the right half. If there are no information updates, then the text “EMPTY” or “NO UPDATES” is rotated.

Circuit operation is typically signified by the generally continuous rotation of information across the screen, such being controlled and operated according to a relatively simple conventional algorithm. More particularly, upon receiving new information, a serial interrupt occurs causing the circuit to cease text rotation and commence data reception. Upon reception, the circuit executes another conventional algorithm that checks and determines which of two or more possible data packet types have been received.

In one scenario, according to a known communications protocol such as NRZ encoding, if a BEGIN_TRANSMISSION data packet is detected, then the receiver circuit recognizes that there is new data to be stored. The circuit ceases text rotation and begins storage of the data being received. To insure that data sent more than once can be ignored, a SAME_TRANSMISSION data packet is sent. This, in turn, does not interrupt circuit operation mode unless an error has been detected in a selected previous send or transmission. Hence, if a SAME_TRANSMISSION data packet is received and a transmission error is found, then the circuit denotes that there is no new data to store and returns to a mode of generally continuous rotation of information across the screen. This occurs, for instance, at selected intervals such as every half-hour. More specifically, a BEGIN_TRANSMISSION or SAME_TRANSMISSION data packet is sent to the receiver circuit for each interval. In this manner, the circuit need not read in data for each interval if only one or a few elements of data have changed. Moreover, if an error is found during any interval, it may be corrected upon the next data send without having to alter the current data. According to one embodiment of the present invention, the foregoing algorithm is also repeated each time an information update is received.

As will be understood by those skilled in the art, as in most wireless environments, data receiver 20 will typically collect “noise” from its surroundings and/or be exposed to other interfering conditions characteristic of wireless transmissions. For best results, it is preferred that each signal 24 received be filtered before being sent to the receiver's microprocessor, e.g., 8051. Since “noise” and other interference is not usually as strong as the intended signal, noise reduction or removal may be accomplished readily using conventional means, such as inverters 29 and capacitors 47, in accordance with various aspects of the present invention.

In one embodiment, the signal is filtered through five (5) capacitors, then inverted three (3) times before being sent to the microprocessor. As those skilled in the art will also appreciate, the number of capacitors, resistors and other filter components that may be suitable will vary depending on hardware combinations and circuit board layouts.

In addition, because memory design requirements of the intended display can exceed considerably the memory capacity of conventional microprocessors, e.g., the 128 bytes of data memory of an 8051 processor, external memory 25 is preferably also provided with the receiver circuit. According to one arrangement, at least 800 bytes of memory is required for data storage for an entire day. Alternatively or concurrently, at 32 kilobytes of random access memory 26 is also provided for accommodating excess or modified data storage requirements.

The receiver is further equipped with a variable capacitor 27 for selected receiver tuning. For example, tuning may be accomplished by mounting a logic analyzer to a pin on the micro-processor that is used for receiving serial data. The variable capacitor is then adjusted, e.g., in relatively small amounts, until a signal of desired quality is achieved. Tuning is considered relatively important for insuring that the microprocessor receives data during circuit operation.

Yet a further embodiment of the present invention provides conventional hardware and software for language processing. More specifically, the message leaving party dials a selected telephone number using a cellular or land-based telephone having a suitable digital voice-recording format such as voicemail. The updated information is input by speaking into the telephone. Upon recording the information, the receiver effects translation of the date into text and displays the same on the message board.

Turning now to another feature of the present invention, as shown in FIGS. 11-13, the system includes a wireless communications device 32 having at least one-way capability, and preferably two-way capability, for allowing the message leaving party to not only post a text-based message, but also update the message from a remote location. In one embodiment, the device includes a keypad 33 for touch-tone data entry and/or a speaker 48 for voice activated data input, a memory device 34 for storing the data input, a microcontroller 35 for processing the data entered and a power source 36, e.g., extended Li-ion Battery 900 mAh, for operating the telephone. In addition, an encoder 37 is provided for encoding the processed data, and a transmitter 38 having an antenna 39 for sending the information, over the wireless interactive communications network, to the local message display 40 of program controlled apparatus 10.

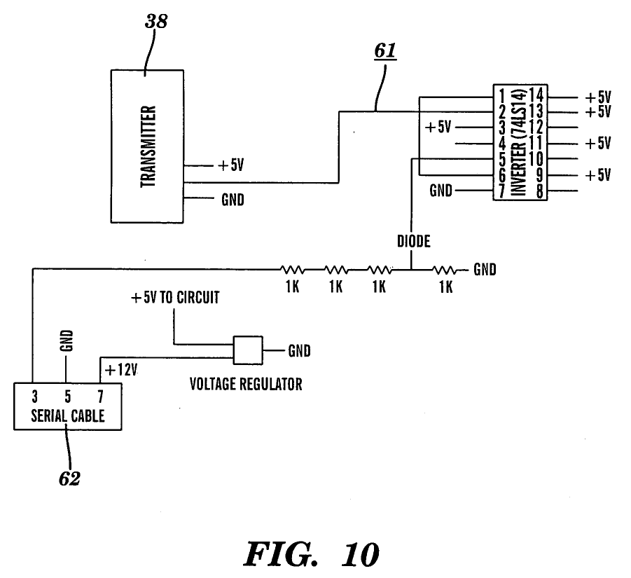

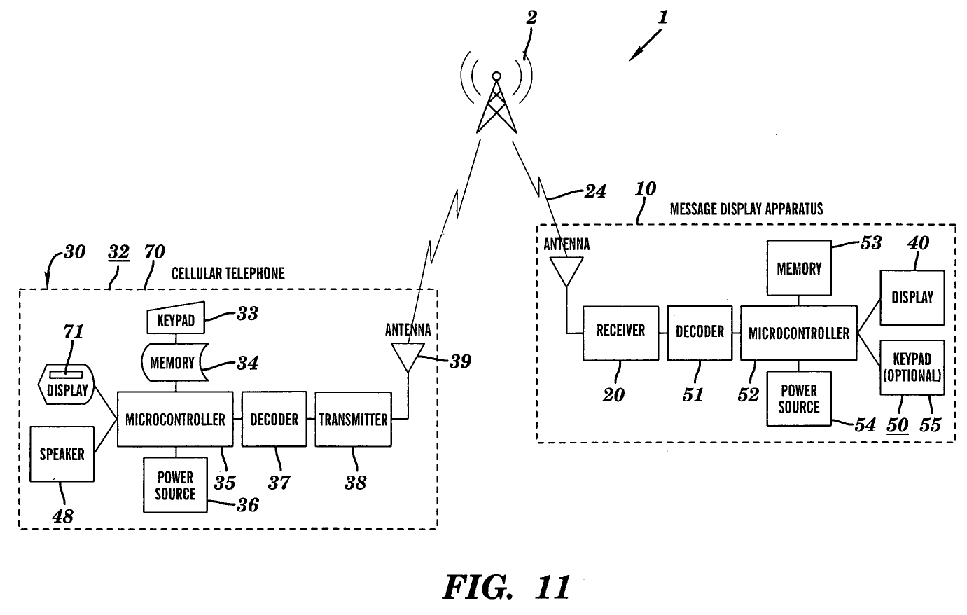

Communications device 30 desirably includes a transmitter circuit 61, set forth in FIG. 10, that connects to a conventional serial port of the device and transmits the data received, over the wireless communications network, to one or more localized data receiver and display units. It is preferred that the device run a monitoring program, more or less continuously, in order to verify, e.g., periodically, that the data received has been received correctly, re-send erroneously received data, and transmit data updates, as appropriate. More particularly, when the transmitter circuit receives data signals over the serial port, the circuit converts the signals to TTL values and forwards them, e.g., at a baud rate of 2400 bits per second, using the RF transmitter. In general, data transmission and reception, in accordance with the present invention, operates at a rate of at least 2400 bits per second.

The transmitter circuit is preferably powered by the serial port or separately by a selected DC power source, e.g., lithium battery. In the serial port or lower power version, the circuit is powered entirely by the serial port through serial cable 62. Should the serial port available provide insufficient power for circuit operation, a higher voltage power source may be implemented, as those skilled in the art will appreciate, within the spirit and scope of the present invention. Alternatively or concurrently, the LT1130CN chip is used to convert data from the serial cable for transmitter circuit operation. Notably, a Microsoft Windows® based platform is considered preferable for software applications relating to data transmission and reception, according to various aspects of the present invention.

Optionally, the transmitter device includes a suitable LCD display, e.g., sixteen (16) characters with backlighting that requires a current of about 0.2 amps for operation. Alternatively, an LCD display without backlighting may be used for reduced energy requirements.

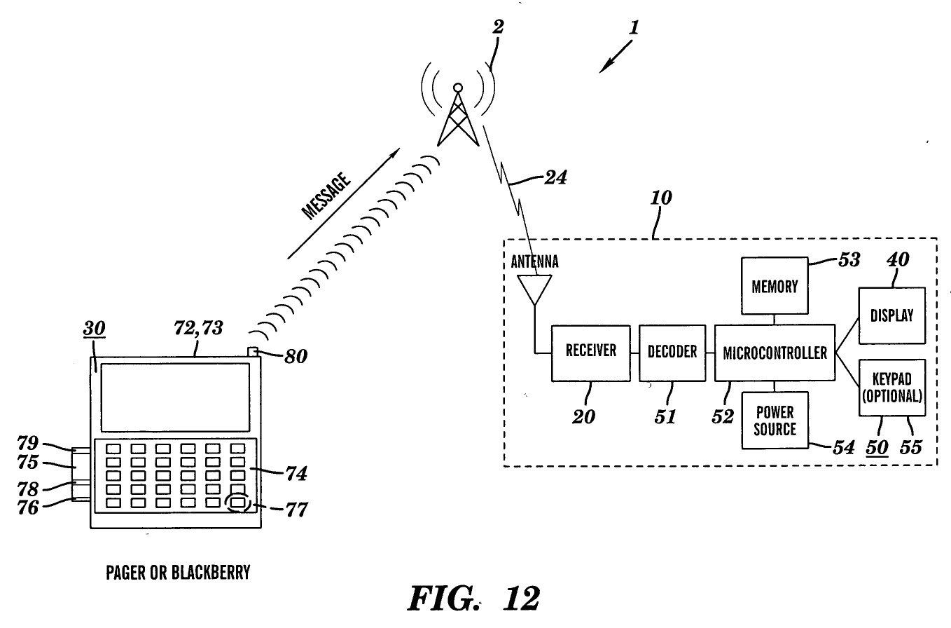

As best seen in FIG. 11, according to one embodiment, the communications device includes a traditional digital cellular telephone 70, e.g., NOKIA 8290. In this connection, the message leaving party simply dials up the wireless data receiver using the keypad 33 provided, follows an appropriate menu 71, and when prompted, generates a revised message and transmits data corresponding to the message to the data receiver. Alternatively or concurrently, as shown in FIG. 12, the wireless communications device is a conventional pager 72 such as the PAGEWRITER 2000X Personal Communicator by Motorola, Inc. and/or a wireless e-mail assistant 73, e.g., the COMPAQ iPAQ BLACKBERRY W1000 of Hewlett-Packard Company. Using the keypad provided, the message leaving party inputs data, follows an appropriate menu, and when prompted, types up a revised message and transmits data corresponding to the message to the data receiver.

Typically, pagers or e-mail assistants include a keypad 74 for data entry, a memory device 75 for storing the data input, a microcontroller 76 for processing the data entered and a power source 77, e.g., an extended life Alkaline battery, for operating the device. In addition, an encoder 78 is provided for encoding the processed data, and a transmitter 79 for sending the information through an antenna 80 over wireless network 2 to message display apparatus 10.

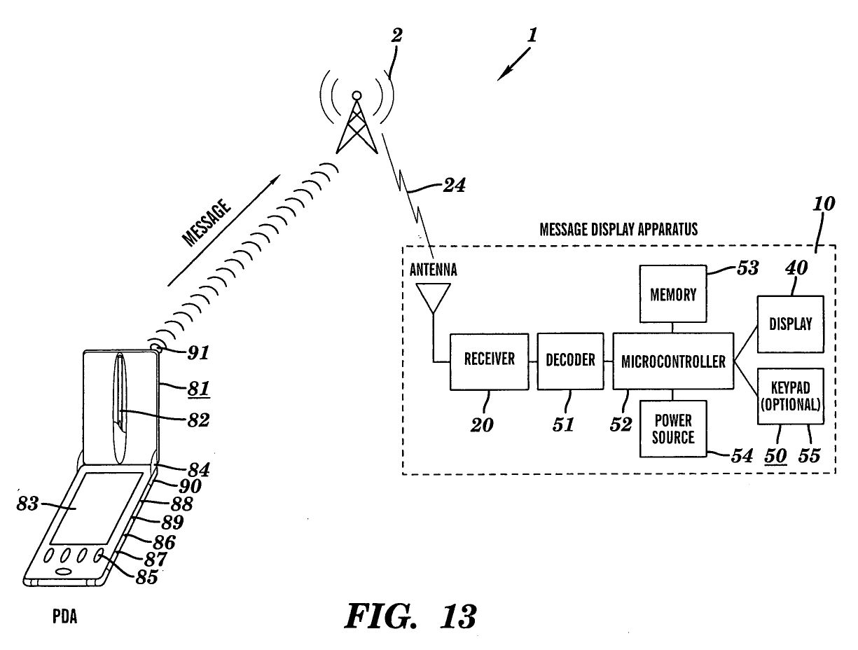

In another embodiment, and further alternatively or concurrently, the wireless communications device takes the form of a personal digital assistant or PDA 81. As best seen in FIG. 13, the device has an electronic pencil 82, a data input and display screen 83 for preparing hand written data messages thereon using the pencil, and a portal 84 for transmitting the data messages to the wireless data receiver. A suitable PDA, e.g., the HP Jornada 568 pocket PC, includes a keypad 85 for data entry, a memory device 86 for storing the data input, a microcontroller 87 for processing the data entered and a power source 88, e.g., an extended life Lithium ion battery, for powering the device. A conventional encoder device 89 is also provided for encoding the processed data, and a transmitter 90 with antenna 91 for sending the information through the antenna, over the wireless network, and to the message display apparatus.

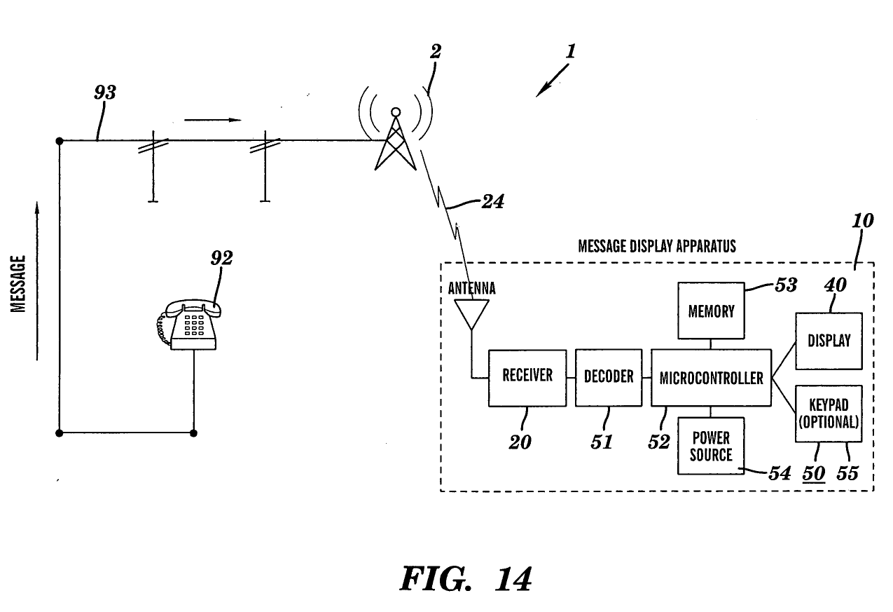

While the present invention has been shown and described for use with a wireless communications device, it is understood that other modes of communication may be integrated with the system; provided, however, that there is suitable accessibility to a wireless communications network and associated compatibility therewith. For example, as shown in FIG. 14, a non-wireless communications device 30 such as a conventional land-based telephone 92 and telephone system 93 is utilized, alternatively to or concurrently with wireless communications device 32, for communicating with message display apparatus 10, giving consideration to the purpose for which the present invention is intended. In addition, a conventional laptop, desktop or palmtop computer with keyboard, keypad and/or voice activation may be used, within the spirit and scope of the present invention.

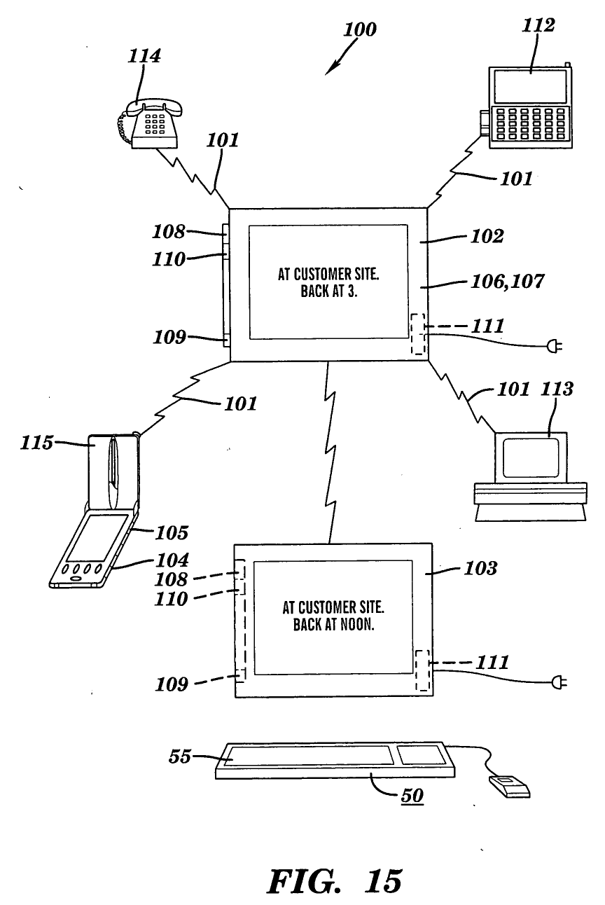

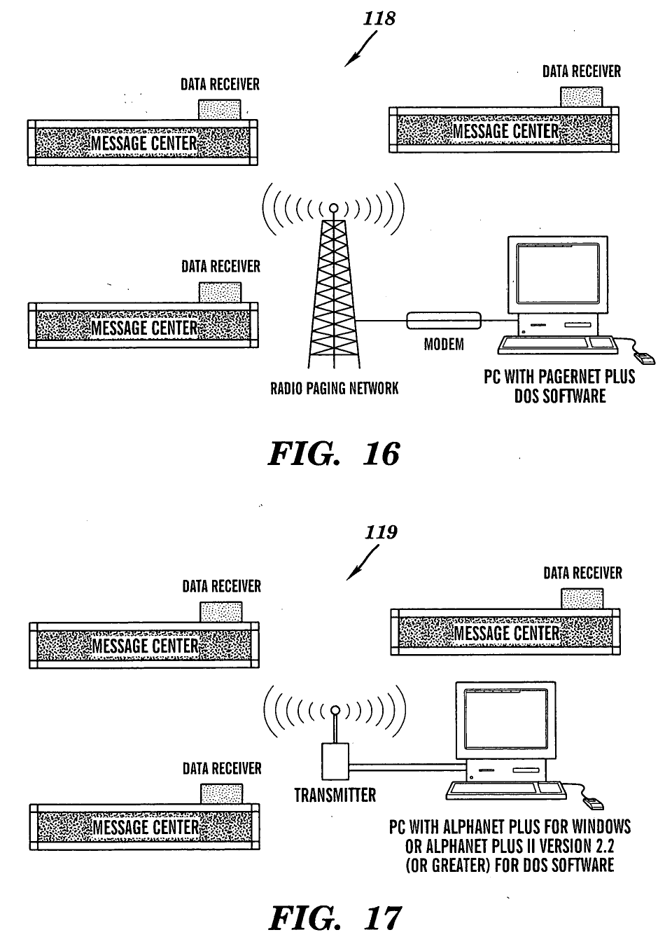

Turning now to another feature of the present invention, as shown in FIG. 15, a multi-user, multi-display system 100, e.g., using an ULTRAGRAPHIX system and display manufactured by Telegenix Inc., is provided for remote data messaging and display over an interactive communications network. According to one embodiment of the present invention, the system includes a wireless communications network 101, such as a wide area wireless network (WAWN) 118 (See FIG. 16), a multi-channel wireless data receiver 102 or a plurality of wireless data receivers 103, a communications device 104 having a portal 105 for transmitting data to the receiver, the receiver having either a relatively small screen display 106, e.g., 11 inches×17 inches, a relatively large screen display 107, e.g., a 12 feet×20 feet billboard, or like alpha numeric and/or graphics based display screen or sign. This arrangement effects remote data messaging and display such as alpha messaging over an interactive wireless communications network, namely, for showing text and graphic data transmitted through the network from a plurality of users. Specifically, the WAWN includes a modem attached to the communications device. To send a message, the modem dials a conventional paging service which, in turn, transmits the message to each wireless data receiver equipped display. Typically, the range of the WAWN is limited only by the range of the paging service.

Alternatively, the system utilizes a local area wireless network (LAWN) 119 in place of the WAWN or concurrently therewith for added system operability. With the LAWN or on-site wireless network, a transmitter attached to the communications device broadcasts text to one or more data receiver equipped displays, the range usually being limited to a few miles. An exemplary LAWN is illustrated in FIG. 17.

The data received is preferably decoded using a conventional decoder device 108, e.g., Motorola Flex or the like. Alternatively, a decoder device is utilized that incorporates decoding logic having ⅗ voting on data blocks received in a frame. The decoded data is clocked out during reception of the first data block of the next frame synchronously with the clock frequency generated from the received data bit flow. An example of such an arrangement is provided in U.S. Pat. No. 5,987,639, issued on Nov. 19, 1999, the disclosure of which is hereby incorporated by reference in its entirety.

A microcontroller 109 associated with each receiver processes the data received, the data being stored subsequently in a memory device 110. The microcontroller also has programming for desired management and display of messages based upon the data received including programming for multi-channel relay of data and public messaging. A power source 111, e.g., a household or commercial 120 Volt AC outlet with an AC/DC adapter connected to the system such as the HP f1781a ultraslim ac/dc adapter, is considered suitable for operating each component of the system.

It is preferred, in the case of a WAWN, that the communications device send messages by dialing a paging service and the service transmits the message to each sign equipped with a data receiver, the range of communications being limited only by the range of the paging service and, of course, related geographic and other environmental considerations. As for operation in a LAWN system or on-site wireless network, which operates alternatively to or concurrently with the WAWN, a transmitter mounted to the communications device broadcasts text and/or graphics based data to one or more signs. Each sign is equipped with a distinct data receiver and the range of the LAWN is usually restricted to relatively small distance such as a few miles or so.

It is also preferred that a multi-channel wireless data receiver be utilized that is suitable for receiving messages from a plurality of message leaving parties 112, 113, 114 and 115 desirous of updating their message posting information on the display screen. A non-mobile, large screen display 107 associated with the receiver, or alternatively, a network of display screens 116, is considered to be most suitable for showing text and graphic data transmitted by multiple parties over the network. The on-site message data input device 50, according to one embodiment, relates to keyboard or keypad 55 which facilitates input and display of data on-site by each message leaving party prior to his/her departure. Notably, the microcontroller is, in addition, provided with programming for time and load-sequencing management of updated data messages received by multiple parties from remote locations, and displaying the same on one or more display screens.

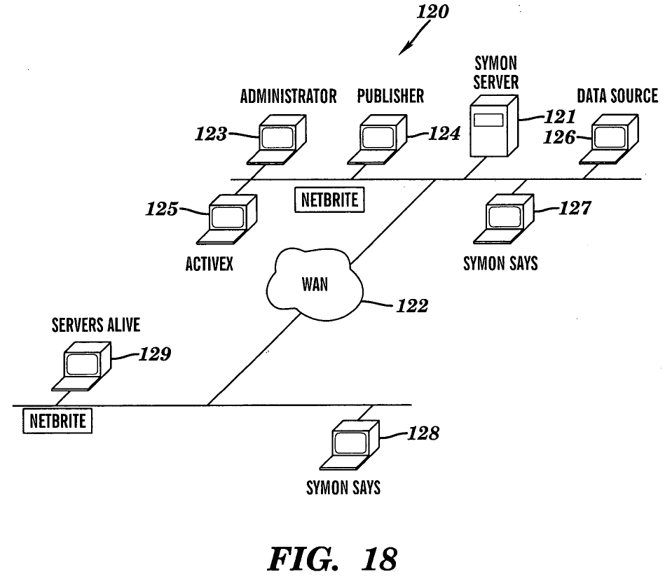

According to still another embodiment of the present invention, a network 120 such as a SYMON 2000 system produced by SYMON Communications Inc. is incorporated into system 10 of the present invention for real-time visual messaging and notification. As shown in FIG. 18, a server 121 located in a first segment of a WAWN 122 operates as an information dispatcher, enabling effective communications with other system components throughout the WAWN. Associated with the same segment as the server, for instance, is an administrator terminal 123, a publisher terminal 124, an ActiveX terminal 125, a data source 126 and a SYMON SAYS terminal 127. In a second segment of the WAWN, a second SYMON SAYS terminal 128 is provided along with a SERVERS ALIVE terminal 129. The SYMON SAYS terminal of the second segment communicates with the server of the first segment and is, thereby, able to send a message to an output device anywhere on the WAWN. Since the SYMON 2000 system supports TCP/EP and because output visual devices are commonly IP addressable, users can locate visual devices virtually anywhere within the WAWN, whether in a particular room of a building or from a remote location.

Optionally, a plurality of message display screens are provided with an infrared audio link between the receiver and one or more display screens so that audio, control and data signals may be transmitted between them in a substantially full-duplex, real time mode. This may be accomplished, for example, using a conventional half-duplex IR-transceiver with suitable FIFO registers and controls. The direction of the half-duplex channel is switched by a system embodied in an IR-link module, having transmission channels for digital full-duplex audio signals, slow and rapid data messages, and for selected control data. The module is connected to a baseband of wireless communications device 32, e.g., a cellular telephone, through a baseband interface (BBIF), and communicates with the same through a media interface (MIF) and an infrared interface (IRIF) with free air space or a light guide. A link-specific, low-level protocol is used for audio and slow data message transmission. A system of this general configuration is described, for instance, in U.S. Pat. No. 6,031,825, issued on Feb. 29, 2000, the disclosure of which is incorporated by reference herein.

In operation, the present invention provides a specific, illustrative method for remote data messaging and display over an interactive wireless communications network. Initially, a message leaving party compiles a message intended for one or more inquiring party. Next, using a communications device having a portal for transmitting message data, the message leaving party transmits data corresponding to the message over a wireless communications network to a wireless data receiver. Upon receiving the message data, the receiver sends the data to a non-mobile display screen for showing the data in text and graphic data formats. The receiver has a microprocessor for decoding, processing and storing the message data received, a power source and programming for desired management and display of messages based upon the data received including programming for allowing the inquiring party to pull selected data therefrom.

Another specific, illustrative method is provided for remote data messaging and display over an interactive wireless communications network. First, a message leaving party compiles a message intended for one or more inquiring party. Then, using a communications device having a portal for transmitting message data, the message leaving party transmits data corresponding to the message over a wireless communications network to a multi-channel wireless data receiver. Upon receiving the message data, the receiver sends the data to a non-mobile, large screen display for showing the data in text and graphic data formats. The receiver has a microprocessor for decoding, processing and storing the message data received, a power source and programming for desired management and display of messages based upon the data received including programming for public messaging.

A further specific, illustrative method is provided for remote data messaging and display over an interactive wireless communications network. A message leaving party compiles and writes a message intended for one or more inquiring party on a non-mobile display screen suitable both for temporary marking and for showing message data electronically in text and graphic data formats. Next, using a communications device having a portal for transmitting message data, the message leaving party transmits data corresponding to the message over a wireless communications network to a wireless data receiver. Upon receiving the message data, the receiver sends the data to a non-mobile display screen for showing the data in text and graphic data formats, the receiver having a microprocessor for decoding, processing and storing the message data received, a power source for operating the screen, receiver and microprocessor, and programming for desired management and display of messages based upon the data received including programming for allowing the inquiring party to pull selected data therefrom.

Consistent with methods of communication contemplated by the present invention, conventional software for alpha messaging may be utilized. An objective is to permit the user to create messages on the communications device, e.g., using a conventional keyboard, keypad or the like. More particularly, this software allows the user to create messages in the color, font and layout desired for the alpha sign, without or without time and date information. Presentation style and idle time are also selected, based upon user preference.

Generally speaking, accessibility of the message leaving party to the inquiry party and of the on-site messaging system to the message updating party are at the apex of the benefits achieved according to various aspects of the present invention. Although the network infrastructure for providing such access has existed for sometime, the present invention has now bridged the gap, allowing any message leaving or updating party to provide updated messaging data from a remote location, without the need for random telephone messages, blanketing the field of user's with data of no interest to most of the recipients, or bothering others near the work-site to update the information on behalf of the updating party.

Hence, the present invention solves a critical and previously unresolved communication problem for the unknown inquiring party—finding out where a messaging leaving party is currently when that party has no pager, cell phone or e-mail assistant with him/her or does not have such device turned on so that, e.g., his/her meeting is not interrupted. This is accomplished by making data available in an information “pull” system so that a message inquiring party may retrieve the data when desired or by simply walking over to the message leaving party's station and reading current messaging data posted on the apparatus of the present invention. In this manner, through the apparatus, system and method of the present invention, data is transmitted to one or more inquiring parties without the need for a personal messaging device.

The present invention further utilizes a program controlled apparatus, system and method for making real-time data available for sharing with groups of data recipients simultaneously, while giving the message leaving party optimum flexibility and convenience from a remote location and without recruiting the assistance of others. It is also readily adaptable to larger, multi-channel public messaging systems without considerable reworking and expense. Moreover, a public messaging system is provided, thereby, that is fast, convenient and practical to use, as well as adaptable for use with any data content.

A message updating party or other user may now transmit data updates remotely without manual intervention by the intended recipient, such as reading e-mail or retrieving and listening to voice mail messages. As a bonus, the apparatus of the present invention accomplishes remote data messaging and display over an interactive wireless communications network, while advantageously retaining a traditional, temporary marking or writing surface for manual on-site messaging needs.

Although the present invention has been shown and described with reference to particular display sizes, e.g., a page size or a billboard size, those skilled in the art will appreciate that display screen size maybe considerably smaller or substantially larger, within the spirit and scope of the present invention, giving consideration to the particular application desired. As an example, for public messaging such as large screen or animated advertising on the side of a large building, a proportionately large cleaning surface with corresponding pixel types such as small timed lights, LED bulbs or the like may be utilized. At the other end of the spectrum, for purposes of leaving small notes or where room for display is somewhat limited, relatively small displays (or even extremely small displays) of correspondingly small and complementary dimensions could be implemented, within the spirit and scope of the present invention.

Overall, the present invention provides a program controlled apparatus and system for remote data messaging and display over an interactive wireless communications network that is durable, reliable and may be operated with minimal skill and vigilance of the user. By using existing network infrastructure and digital communications devices, the present invention is both efficient and economical to implement as well as operate. Beneficially, the apparatus of the present invention may also be constructed of low cost materials.

Various modifications and alterations to the present invention may be appreciated based on a review of this disclosure. These changes and additions are intended to be within the scope and spirit of this invention as defined by the following claims.

What is claimed is:

1. A system for remote data messaging and display over an interactive wireless communications network, which comprises a wireless communications network, a wireless data receiver, a communications device having a portal for transmitting data to the receiver, a display screen associated with the receiver for showing text and graphic data transmitted over the network, a microprocessor associated with the receiver for decoding, processing and storing data received and a power source for operating the system, the system having programming for management and display of messages based upon the data received, and for allowing a data inquiring party to pull selected data.

2. The system set forth in claim 1 wherein the display screen is of a non-mobile type.

3. The system set forth in claim 1 wherein the communications device is a cellular telephone.

4. The system set forth in claim 1 wherein the communications device is a pager device.

5. The system set forth in claim 1 wherein the communications device is an e-mail assistant.

6. The system set forth in claim 1 wherein the communications device is a personal digital assistant.

7. The system set forth in claim 1 wherein the power source is a plurality of batteries.

8. The system set forth in claim 1 wherein the display screen is a liquid crystal display.

9. A system for remote data messaging and display over an interactive wireless communications network, which comprises a wireless communications network, a multi-channel wireless data receiver, a communications device having a portal for transmitting data to the receiver, a non-mobile, large screen display associated with the receiver for showing text and graphic data transmitted through the network, a power source for operating the system, and a microprocessor associated with the receiver for decoding, processing and storing data received, the system having programming for management and display of messages based upon the data received, and for public messaging.

10. A system for remote data messaging and display over an interactive wireless communications network, which comprises a wireless communications network, a wireless data receiver, a communications device having a portal for transmitting data to the receiver, a non-mobile display screen associated with the receiver for showing text and graphic data transmitted over the network and suitable for temporary marking, a power source for operating the system, and a microprocessor associated with the display screen for decoding, processing and storing data received, the system having programming for management and display of messages based upon the data received, and for allowing a data inquiring party to pull selected data.

11. A system for remote data messaging and display over an interactive wireless communications network, the system comprising:
a wireless communications network;
a wireless data receiver;
a wireless communications device having an electronic pencil, a data input and display screen for preparing hand written data messages thereon using the electronic pencil, and having a portal for transmitting the data messages to the wireless data receiver;
a page size, LCD display surface suitable for electronic marking and for showing the hand written data messages transmitted over the network;
a message input device including an electronic pencil for on-site data input;
a power source for operating the apparatus; and
a microprocessor associated with the display surface for decoding, processing and storing data input on-site or received remotely, the system having programming for management and display of messages based on the data input on-site or received remotely.

12. A program controlled apparatus for remote data messaging and display over an interactive wireless communications network, the apparatus including a wireless data receiver, a non-mobile display screen for showing text and graphic data transmitted over the network, a power source for operating the apparatus, a message input device for on-site data input, and a microprocessor associated with the display screen for decoding, processing and storing data input on-site or received remotely, the system having programming for management and display of messages based upon data input on-site or received remotely.

13. The apparatus set forth in claim 12 wherein the message input device is a keyboard.

14. The apparatus set forth in claim 12 wherein the message input device is a keypad.

15. The apparatus set forth in claim 12 wherein the message input device is an electronic pencil.

16. A program controlled apparatus for remote data messaging and display over an interactive wireless communications network, the apparatus including a wireless data receiver, a non-mobile display screen suitable for temporary marking for showing text and graphic data transmitted over the network, a power source for operating the apparatus, a message input device for on-site data input, and a microprocessor associated with the display screen for decoding, processing and storing data input on-site or received remotely, the apparatus having programming for management and display of messages based upon data input on-site or received remotely.

17. The apparatus set forth in claim 16 further comprising a mechanical instrument for writing text and/or graphically based messages for temporary display on the display screen.

18. The apparatus set forth in claim 17 wherein the display screen has a first display zone for display of messages based on data input on-site or received remotely.

19. The apparatus set forth in claim 17 wherein the display screen has a second display zone for display of written text and/or graphically based messages for temporary display on the display screen.

20. A program controlled apparatus for remote data messaging and display over an interactive wireless communications network, the apparatus including a multi-channel wireless data receiver, a non-mobile, large screen display associated with the receiver for showing text and graphic data transmitted over the network, a message input device for on-site data input, a power source for operating the apparatus, and a microprocessor associated with the receiver for decoding, processing and storing data input on-site or received remotely, and programming for management and display of messages based upon data input on-site or received remotely, the multi-channel receiver allowing for different user's updating their information on a single screen.

21. A program controlled apparatus for remote data messaging and display over an interactive wireless communications network, the apparatus including a wireless data receiver, a page size, LCD display surface suitable for temporary marking and for showing text and graphic data transmitted over the network, a message input device including a keyboard for on-site data input, a power source for operating the apparatus, and a microprocessor associated with the display surface for decoding, processing and storing data input on-site or received remotely, the apparatus having programming for management and display of messages based on the data input on-site or received remotely.

22. A program controlled apparatus for remote data messaging and display over an interactive wireless communications network, the apparatus including a wireless data receiver, a page size, LCD display surface suitable for electronic marking and for showing text and graphic data transmitted over the network, a message input device including an electronic pencil for on-site data input, a power source for operating the apparatus, and a microprocessor associated with the display surface for decoding, processing and storing data input on-site or received remotely, the apparatus having programming for management and display of messages based on the data input on-site or received remotely.

23. A method for remote data messaging and display over an interactive wireless communications network, which comprises the steps of:
compiling a message intended for one or more inquiring party;
using a communications device having a portal for transmitting message data, transmitting data corresponding to the message over a wireless communications network to a wireless data receiver;
upon receiving the message data, sending the data to a non-mobile display screen for showing the data in text and graphic data formats, the receiver having a microprocessor for decoding, processing and storing the message data received, a power source and programming for management and display of messages based upon the data received including programming for allowing the inquiring party to pull selected data therefrom.

24. A method for remote data messaging and display over an interactive wireless communications network, which comprises the steps of:
compiling a message intended for at least one inquiring party;
using a communications device having a portal for transmitting message data, the transmitting data corresponding to the message over a wireless communications network to a multi-channel wireless data receiver; and
upon receiving the message data, sending the data to a non-mobile, large screen display for showing the data in text and graphic data formats, the receiver having a microprocessor for decoding, processing and storing the message data received, a power source and programming for management and display of messages based upon the data received including programming for public messaging.

25. A method for remote data messaging and display over an interactive wireless communications network, which comprises the steps of:
compiling and writing a message intended for at least one inquiring party on a non-mobile display screen suitable both for temporary marking and for showing message data electronically in text and graphic data formats;
using a communications device having a portal for transmitting message data, transmitting data corresponding to the message over a wireless communications network to a wireless data receiver;
upon receiving the message data, sending the data to a non-mobile display screen for showing the data in text and graphic data formats, the receiver having a microprocessor for decoding, processing and storing the message data received, a power source for operating the screen, receiver and microprocessor, and programming for management and display of messages based upon the data received including programming for allowing the inquiring party to pull selected data therefrom.
